(19) United States
(12) Patent Application Publication
(10) Pub. No.: US 2021/0288331 A1
(43) Pub. Date: Sep. 16, 2021

(54) CATALYST SYSTEM, ELECTRODE, AND FUEL CELL OR ELECTROLYZER

(71) Applicant: Schaeffler Technologies AG & Co. KG, Herzogenaurach (DE)

(72) Inventors: Moritz Wegener, Erlangen (DE); Yashar Musayev, Nürnberg (DE); Jeevanthi Vivekananthan, Herzogenaurach (DE); Detlev Repenning, Reinbeck (DE); Ladislaus Dobrenizki, Höchstadt (DE)

(73) Assignee: Schaeffler Technologies AG & Co. KG, Herzogenaurach (DE)

(21) Appl. No.: 17/257,696

(22) PCT Filed: Apr. 10, 2019
(86) PCT No.: PCT/DE2019/100331

§ 371 Date: Jan. 4, 2021

(30) Foreign Application Priority Data
Jul. 9, 2018 (DE) 10 2018 116 508.0

(51) Int. Cl. H01M 4/90; H01M 4/92; H01M 4/86

(52) U.S. Cl. CPC H01M 4/9016; H01M 4/8668; H01M 4/921; H01M 4/926

(57) ABSTRACT

A catalyst system comprises an electrically conductive carrier metal oxide and an electrically conductive, metal oxide catalyst material, wherein the carrier metal oxide and the catalyst material differ in their composition and wherein the catalyst material and the carrier metal oxide are each stabilized with fluorine. A near-surface pH value, designated pzzp value (pzzp=point of zero zeta potential), of the carrier metal oxide and of the catalyst material differ from one another, wherein the pzzp value of either the carrier metal oxide or the catalyst material is at most pH=5. The catalyst material and the carrier metal oxide form an at least two-phase disperse oxide composite. The catalysts system may be used in an electrode which may be used in a fuel cell or an electrolyzer.

### CROSS-REFERENCE TO RELATED APPLICATIONS

This application is the U.S. National Phase of PCT Appln. No. PCT/DE2019/100331 filed Apr. 10, 2019, which claims priority to DE 10 2018 116 508.0 filed Jul. 9, 2018, the entire disclosures of which are incorporated by reference herein.

### TECHNICAL FIELD

The disclosure relates to a catalyst system comprising a carrier metal oxide and a metal oxide catalyst material. The disclosure further relates to an electrode, which comprises the catalyst system. The disclosure further relates to a fuel cell or an electrolyzer comprising at least one such electrode and a polymer electrolyte membrane.

### BACKGROUND

For more than 20 years, leading automobile manufacturers have been working on fuel cells with hydrogen as an energy carrier. In the entire chain, from production from raw materials to recycling, fuel cells have a favorable carbon footprint, although the efficiency of fuel cells together with hydrogen generation from renewable sources is significantly lower than that of battery-powered cars. Furthermore, fuel cells have significantly worse performance dynamics than batteries. The reason for this is that the reactants hydrogen and oxygen can only be transported into the reaction chambers of the fuel cell with a time delay in the event of sudden power requirements. This is why the model of a hybrid system consisting of a fuel cell and a lithium battery is becoming increasingly popular. The fuel cell takes over the basic load in the driving behavior of the car and the battery is switched on as a “power generator” for the short power peaks in the typical driving cycles of a car.

The focus is therefore on increasing the efficiency of fuel cells. Fuel cells have a theoretical, thermodynamically based efficiency of approx. 90-95% in the operating temperature window of T=80-90° C. for the polymer electrolyte membrane fuel cells. Technically, however, efficiencies of only 50-60% are currently achieved in the best case. One of the main reasons for this is the high overvoltages of the oxygen reduction reaction on a platinum catalyst. So far, platinum has been considered the best catalyst for reducing oxygen in a fuel cell, but owing to its high price it should be avoided or at least used very sparingly.

Oxide-based compounds, for example, are another class of catalysts. US 2015/0368817 A1 discloses a catalyst system for the anode side of an electrolyzer, comprising a support and a plurality of catalyst particles which are arranged on the support. The carrier comprises a plurality of metal oxide particles or doped metal oxide particles. The catalyst particles are based on the precious metals iridium, iridium oxide, ruthenium, ruthenium oxide, platinum or platinum black and are therefore correspondingly expensive. The particles of the carrier including the catalyst particles are dispersed in a binder.

DE 10 2008 036 849 A1 discloses a bipolar plate unit for a fuel cell comprising a base body, a coating on the anode side and a coating on the cathode side, wherein the coatings are composed differently. The coating on the cathode side comprises a metal oxide, in particular in the form of tin oxide, which is doped with fluorine.

### SUMMARY

It is desirable to provide a catalyst system for the improved reduction of oxygen, in particular for use in fuel cells or electrolyzers, which manages without precious metals or with only a very small use of precious metals. A fuel cell and an electrolyzer comprising such a catalyst system should result in improved efficiency.

The object is achieved for the catalyst system in that
an electrically conductive carrier metal oxide having an electrical conductivity σ1 of at least 10 S/cm is comprehensively formed, wherein the carrier metal oxide has at least two first metallic elements selected from the group of non-precious metals and has a structure comprising oxide grains with a grain size of at least 30 nm,
an electrically conductive, metal-oxide catalyst material having an electrical conductivity σ2 of at least 10 S/cm is comprehensively formed, wherein the catalyst material has at least one second metallic element from the group of non-precious metals, wherein the first metallic elements in the carrier metal oxide and the at least one second metallic elements are each present in the catalyst material in a solid stoichiometric compound or solid homogeneous solution, wherein the carrier metal oxide and the catalyst material differ from one another in their composition and are each stabilized with fluorine, and

wherein a near-surface pH value, designated pzzp value (pzzp=point of zero zeta potential), of the carrier metal oxide and of the catalyst material differ from one another, wherein the pzzp value of either the carrier metal oxide or the catalyst material is at most pH=5, and the catalyst material and the carrier metal oxide form an at least two-phase disperse oxide composite.

The advantage of the acidic catalyst on the surface is that the oxygen reduction is more easily shifted towards the product (water) in accordance with the law of mass action.

In a particularly preferred embodiment of the catalyst system, the pzzp value of either the carrier metal oxide or the catalyst material is at most pH=3. The advantage of the catalyst, which is set to be even more acidic on the surface, is that the oxygen reduction is shifted even more easily in the direction of the product (water) in accordance with the law of mass action.

The catalyst material can be inherently disperse or coherently disperse in the support metal oxide and/or deposited on a surface of the support metal oxide.

The catalyst system manages without precious metals. It is therefore interesting in terms of price and opens up great potential for cost savings, especially in the automotive industry.

The support metal oxide and the oxidic catalyst material are stabilized by doping them with fluorine. In particular, the proportion of fluorine in the catalyst system is a maximum of 2 mol % based on the oxygen content. The fluorine is evenly distributed in the oxide lattice and increases the long-term chemical stability and electrical conductivity of the carrier metal oxide and the catalyst material of the catalyst system.

In particular, the first metallic elements for forming the carrier metal oxide comprise at least two metals from the group consisting of tin, tantalum, niobium, titanium, hafnium and zirconium. In particular, first metallic elements are used in combination, the electrochemical valence of which is different. In particular, the first metallic elements include tin and furthermore at least one metal from the group consisting of tantalum, niobium, titanium, hafnium and zirconium. A combination of the first metallic elements tin and tantalum or tin and niobium is particularly preferred. With a solid solution of 1.1 mol % tantalum oxide Ta₂O₅ in tin oxide SnO₂ or 2.1 mol % Nb₂O₅ in tin oxide SnO₂, the carrier metal oxide achieves an electrical conductivity σ1 in the range of 7*10²S/cm. However, combinations of tin and titanium, tin and hafnium, tin and zirconium, titanium and tantalum, titanium and niobium, zirconium and niobium, zirconium and tantalum, hafnium and niobium or hafnium and tantalum have proven to be useful here for the formation of the carrier metal oxide.

The oxidic catalyst material preferably has a structure comprising oxide grains with a grain size in the range from 1 nm to 50 nm. The at least one second metallic element of the oxidic catalyst material is preferably formed by at least one non-precious metal from the group consisting of tantalum, titanium, niobium, zirconium, hafnium, iron and tungsten. In particular, at least two second metallic elements are used in combination. The second metallic elements in particular have an electrochemical valence that is different, such as (Ta,Fe)₂O₅, (Ti,Fe)O₂, (Nb,W)₂O₅ and the like.

The carrier metal oxide has a first crystal lattice structure comprising first oxygen lattice sites and first metal lattice sites, wherein the carrier metal oxide on the first metal lattice sites on which the first metallic elements are arranged is preferably doped with at least one element from the group including titanium, zirconium, hafnium, vanadium, niobium, tantalum, aluminum, iron, tungsten, molybdenum, iridium, rhodium, ruthenium and platinum. In this case, doping elements are selected whose valence is different from the first metallic elements. The doping element is preferably installed on a first metal lattice site instead of a first metallic element. The doping is preferably present in a molar fraction of at most 0.1 of the first metallic elements in the carrier metal oxide.

The carrier metal oxide has a first crystal lattice structure comprising first oxygen lattice sites and first metal lattice sites, wherein the carrier metal oxide on the first oxygen lattice sites is preferably doped with at least one element from the group comprising nitrogen, carbon and boron. The doping element replaces oxygen on a first oxygen lattice site. The doping is preferably present in a molar fraction of at most 0.06, based on non-metallic elements in the carrier metal oxide.

The catalyst material has a second crystal lattice structure comprising second oxygen lattice sites and second metal lattice sites, wherein the catalyst material on the second metal lattice sites is preferably doped with at least one element from the group comprising titanium, zirconium, hafnium, vanadium, niobium, tantalum, iron, tungsten, molybdenum, iridium, rhodium, ruthenium and platinum.

The use of iridium to adjust the electrical conductivity is particularly preferred as a stable generator of mixed oxide phases. In this case, doping elements are selected that are different from the at least one second metallic element. The doping element is preferably installed on a second metal lattice site instead of a second metallic element. The doping is preferably present in a molar fraction of at most 0.1 of the at least one second metallic element.

Platinum can additionally be applied to a surface of the catalyst system in an amount of at most 0.1 mg/cm² based on a coating area and independently of a coating thickness of the catalyst system. This increases the conductivity of the catalyst system without significantly increasing the costs therefor.

The object is also achieved for an electrode which comprises a catalyst system. The current densities that can be achieved with an electrode of this type are 5 to 8 times higher at a cell voltage in the range from 700 to 800 mV than with the known oxide compounds from the prior art mentioned above. In particular, the electrode is designed as a cathode.

The electrode furthermore preferably comprises at least one ionomer and at least one binder. The at least one binder preferably comprises at least one fluorinated hydrocarbon and/or at least one polysaccharide. In particular, the polysugar consists of carboxymethyl cellulose and/or xanthan and/or alginate and/or agar-agar and/or another acid-stable polysugar.

The electrode preferably has a coating thickness in the range of from 0.5 to 20 μm.

In an advantageous further development, platinum is applied to a free surface of the electrode in an amount of at most 0.2 mg/cm′. This increases the electrical conductivity of the electrode, again without significantly increasing the costs therefor.

The object is also achieved for a fuel cell or an electrolyzer in that they are designed to include at least one electrode as described above and at least one polymer electrolyte membrane. In particular, the fuel cell is an oxygen-hydrogen fuel cell.

In particular, the electrode forms the cathode of a cell. The electrode is preferably arranged on a cathode side of a bipolar plate, wherein a gas diffusion coating can be arranged between the electrode and a metallic carrier plate of the bipolar plate.

The polymer electrolyte membrane and the ionomer of the electrode are preferably formed from identical materials. This significantly improves the transport of the oxygen ions formed on the surface of the electrode designed as a cathode, i.e., the cathode surface, to the polymer electrolyte membrane and thus significantly improves the efficiency of a fuel cell or an electrolyzer.

### BRIEF DESCRIPTION OF THE DRAWINGS

FIGS. 1 to 6 and Table 1 are intended to explain the catalysts system in an exemplary manner. In the figures:

FIG. 1 shows a bipolar plate having an electrode containing the catalyst system;

FIG. 2 schematically shows a fuel cell system comprising a plurality of fuel cells;

FIG. 3 shows a section through the arrangement according to FIG. 1;

FIG. 4 shows a section through two bipolar plates and a polymer electrolyte membrane according to FIG. 2 arranged there between;

FIG. 5 shows a phase diagram of Ta₂O₅—SnO₂ above 1200° C.; and

FIG. 6 shows the calculated activities of Ta₂O₅ and SnO₂ at 1500° C.

### DETAILED DESCRIPTION

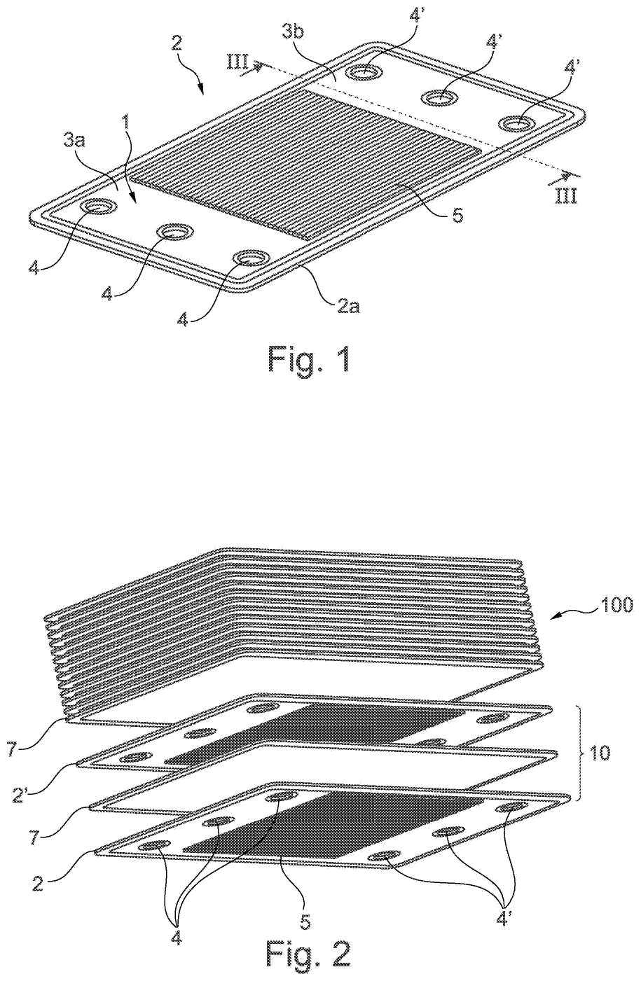

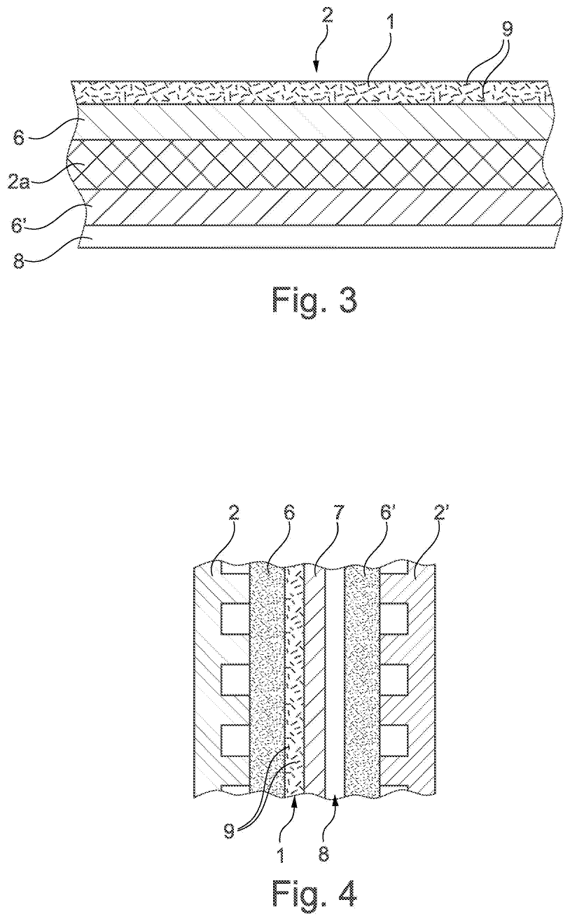

FIG. 1 shows an electrode 1 on a bipolar plate 2 which has a carrier plate 2a. The electrode 1 contains the catalyst system 9 (see FIG. 3) and forms a cathode. The electrode 1 has a coating thickness in the range of from 1 to 2 μm and, in addition to the catalyst system 9, also comprises an ionomer and a binding agent in the form of agar-agar. The bipolar plate 2 has an inflow area 3a with openings 4 and an outlet area 3b with further openings 4′ which are used to supply a fuel cell with process gases and to remove reaction products from the fuel cell. The bipolar plate 2 also has a gas distribution structure 5 on each side, which is provided for contact with a polymer electrolyte membrane 7 (see FIG. 2).

FIG. 2 schematically shows a fuel cell system 100 comprising a plurality of fuel cells 10. Each fuel cell 10 comprises a polymer electrolyte membrane 7 which is adjacent to both sides of bipolar plates 2, 2′. The same reference symbols as in FIG. 1 indicate identical elements.

FIG. 3 shows a section through the bipolar plate 2 according to FIG. 1. The same reference symbols as in FIG. 1 indicate identical elements. The carrier plate 2a, which is formed here from stainless steel, can be seen, which can be constructed in one part or in several parts. A gas diffusion coating 6 is arranged between the carrier plate 2a and the electrode 1 which contains the catalyst system 9. It can also be seen that a further anode-side coating 8 of the carrier plate 2a is provided. This is preferably a coating 8 which is designed according to DE102016202372 A1. A further gas diffusion coating 6′ is located between the coating 8 and the carrier plate 2a. The gas diffusion coatings 6, 6′ are designed to be electrically conductive, and in particular are made of a fiber mat made of carbon material.

FIG. 4 shows a section through two bipolar plates 2, 2′ and a polymer electrolyte membrane 7 according to FIG. 2 arranged therebetween, which together form a fuel cell 10. The same reference symbols as in FIGS. 1 and 3 indicate identical elements. It can be seen that the electrode 1 of the bipolar plate 2 as the cathode and the coating 8 of the bipolar plate 2′ as the anode are arranged adjacent to the polymer electrolyte membrane 7. The gas diffusion coatings 6, 6′ can also be seen.

In the following, a catalyst system 9 is presented using the example of the quasi-binary oxide phase diagram Ta₂O₅—SnO₂.

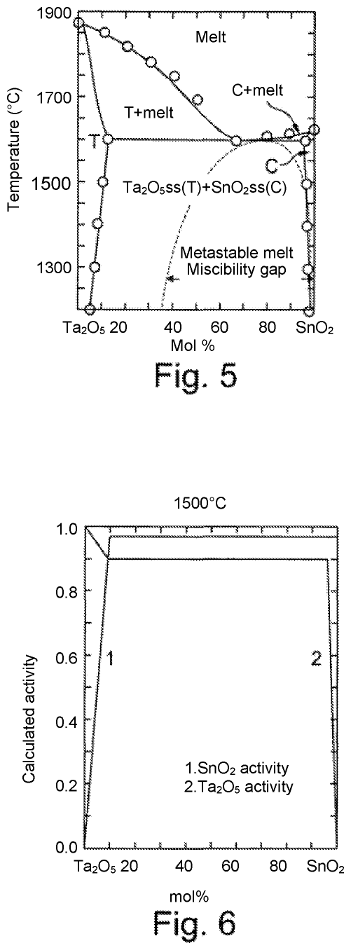

FIG. 5 shows a calculated phase diagram for the catalyst system Ta₂O₅—SnO₂ for temperatures above T=1200° C., which originates from the dissertation “The Impact of Metal Oxides on the Electrocatalytic Activity of Pt Catalysts” by A. Rabis, ETH Zurich 2015. The mutual solubilities at lower temperatures must be extrapolated and estimated. The phase diagram shows that tin oxide in tantalum oxide has an initial solubility of about 7 mol % at the temperature mentioned, while the initial solubility of tantalum oxide in tin oxide is 1.1 mol %. It can accordingly be assumed that the solubilities are lower at room temperature or the operating temperature of a fuel cell.

The activity profile of the two oxides at 1500° C. in the respective mixed phases is as shown in FIG. 6 (J. Am. Ceram. Soc., 95 [12], 4004-4007, (2012)). The stable thoreaulite phase SnTa₂O₇ is not included in this phase diagram according to FIG. 6. The tin is tetravalent in this compound. In the solid solution of tin oxide with tantalum oxide, the electrical conductivity of the tin oxide is drastically increased. With an addition of tantalum oxide up to a maximum α solubility of 1.1 mol % to tin oxide, electrical conductivities of 7×10²S/cm² are achieved.

The increase in electrical conductivity increases steadily with the concentration of the solution up to the aforementioned phase boundary and then decreases again. When the solubility limit according to the phase diagram shown in FIG. 6 is exceeded, a two-phase region is formed from the SnO₂—Ta₂O₅ phase and the thoreaulite SnTa₂O₇ in equilibrium. The composition of the heterogeneous structure can be calculated with given concentrations according to the lever law. If, for example, a total concentration of 10 mol % Ta₂O₅ in SnO₂ is chosen, the result is a composition of the heterogeneous structure of 88% Sn_{0.99}Ta_{0.01}O₂ and 2% SnTa₂O₇ as oxide composite.

The electrically highly conductive tin dioxide phase Sn_{0.99}Ta_{0.01}O₂ forms the carrier metal oxide and the thoreaulite phase SnTa₂O₇ forms the catalyst material which is finely dispersed in the grain of the carrier metal oxide. The precipitation conditions are determined on the one hand by the grain size produced and on the other hand by the temperature-time diagram for setting the structure. By varying the composition, the proportions of the two phases of the oxide composite are changed.

However. the chemical activities of the first and second metallic elements in the oxides remain unchanged in the two-phase region, as do the respective basic electrical and chemical-physical properties. For catalysis, the triple phase boundary lengths) as well as the energetic surface states of the carrier metal oxide can be set via the quantity and size ratios. Since the two phases, i.e., the carrier metal oxide and the catalyst material, are present in crystallographic structures that differ from one another, they are inherently dissolved with one another, i.e., the catalyst material is present as inherently dissolved dispersoids in the carrier metal oxide.

With RDE investigations (RDE=ring disc electrode) it was found that both the tantalum-rich β phase and the thoreaulite phase SnTa₂O₇ have a comparatively good catalytic activity for oxygen reduction. This was verified with experiments in which the catalyst system was treated with a solution containing 2-[1-[difluoro[(trifluoroethenyl) oxy]methyl]-1,2,2,2-tetrafluoroethoxy]-1,1,2,2-tetrafluoroethanesulfonic acid as a polymer electrolyte material or ionomer, also known under the trade names Nation or Flemion, was applied to a carbon substrate (glassy carbon) to form an electrode. The onset voltages U were in the range of platinum. However, the specific currents i found were low: i<0.1 A/cm² at U=0.65 V.

In the next step, the individual phases were eliminated from the two-substance mixture. As stated above, the carrier metal oxide used was SnO₂ with about 1 mol % Ta₂O₅, wherein the mass fraction of this phase was in the range from 70 to 95% by weight.

Table 1 below shows the results of the catalyst systems. The results were determined by means of a single cell consisting of two end plates, two graphite plates, two bipolar plates 2, 2′ made of graphite, two gas diffusion coatings 6, 6′, the electrode 1 (cathode side), a standard Pt/C catalyst (anode side) and a polymer electrolyte membrane 7 made from Nation. The process gases, here air and hydrogen, were humidified differently on the cathode side and the anode side.

The electrode 1 had an electrode area of 30 mm×30 mm. The cell was operated at T=85° C. with p=2.5 bar. On the hydrogen side, λ=1.5 was set, and λ=2 on the air side. A reference humidification temperature TB was set at 80° C.

The prepared coating thicknesses of the electrode 1 were in the range of from 1 to 5 μm.

TABLE 1

| Ratio of carrier | | | | |
|---|---|---|---|---|
| (metal oxide)/ | | Grain size of the | I (A/cm²) | Onset |
| catalyst | Carrier (metal oxide)/ | carrier metal | & 0.7 V | voltage |
| material in wt. % | catalyst material | oxide in nm | (T = 85° C.) | in VNHE |
| 80/20 | C/Pt | 2-4 | 1.1 | 0.95 |
| 50/7 | SnO₂—1%Ta₂O₅/ | 100-125 | 0.65 | 1.05 |
| | Ta₂O₅-dot. | | | |
| 35/15 | SnO₂—1%Ta₂O₅/ | 100-125 | 0.75 | 1.1 |
| | Ta₂O₅-dot. | | | |
| 35/15 | SnO₂—1%Ta₂O₅/ | 100-125 | 1.4 | 1.1 |
| | Ta₂O₅-dop.-0.1%Pt | | | |
| 50/7 | SnO₂—2.5%Nb₂O₅/ | 80-100 | 0.5 | 1.15 |
| | Ta₂O₅-dot. | | | |
| 35/15 | SnO₂—2.5%Nb₂O₅/ | 80-100 | 0.8 | 1.2 |
| | Ta₂O₅-dop. | | | |
| 35/15 | SnO₂—2.5%Nb₂O₅/ | 100-125 | 1.35 | 1.2 |
| | Ta₂O₅-dop.-0.1%Pt | | | |
| 30/10 | SnO₂—2.5%Nb₂O₅/ | 80-100 | 0.95 | 0.85 |
| | (Ti90Nb10)O₂—0.1%Pt | | | |

According to Table 1, the current densities for catalyst systems are 5 to 8 times higher than in experiments in which individual oxidic phases were deposited on a carbon substrate. The results in Table 1 impressively show that it is possible to produce platinum-free and carbon-free electrodes with similarly good activities as in the conventional system of “platinum on carbon carriers”.

The triple phase boundary length (TPB), the nanodisperse precipitated electrocatalytically active thoreaulite phase (=catalyst material) as well as the size of the individual grains in the microstructure can be optimized via the precipitation conditions from the Sn—Ta—O system. In this way, the electrolytic activity of the catalyst system for oxygen reduction can also be optimized.

The conductivity of the tin oxide, in which the tantalum oxide is dissolved up to the maximum limit solubility (approx. 1.1 mol %), depends heavily on the sintering temperature. It is important to ensure that the oxygen partial pressure above the powder is always high enough that the fully oxidized compounds are established. Otherwise, post-oxidation during cell operation and loss of activity can be expected. It is currently unclear whether the thoreaulite phase or the tantalum-rich β phase actually occurs under the oxidative test conditions chosen. According to the test results, this is not decisive for the effectiveness of the catalyst system.

Furthermore, a sintering temperature must be set so high that later grain agglomeration is not to be expected and, on the other hand, the catalyst system is sufficiently stable even for use at lower temperatures. This risk would exist if the mutual solubilities in the α and β phases were to change significantly. This is why the temperature program was chosen in such a way that initially sintering was carried out at higher temperatures of up to T=900° C. and the grain was adapted as closely as possible to the conditions in cell operation in the cooling program. Accordingly, a holding phase at T=250° C. over a period of 60 minutes is preferably set in the cooling program.

Furthermore, a study was made of how further deposition of nanodisperse platinum particles affects the electrocatalytic effectiveness of the catalyst system. The platinum was deposited on the surface of the coating 6 by means of sputtering technology with an area coverage of <0.1 mg/cm′. The platinum cluster sizes were determined from different samples by means of TEM measurements and X-ray diffractometry.

When comparing the values determined by TEM measurement with those obtained by X-ray diffractometry, it has been shown that similar cluster sizes are obtained with both methods (TEM: 6-11 nm; XRD: 7 nm). Only statements about the tendencies in changes of cluster sizes should be made here. For this reason, the cluster sizes were determined by means of X-ray diffractometry, as this method is not only much easier to carry out, but also contains broader statistical information, since only a small section of the sample can be viewed with TEM measurements.

Overall, it can be stated that surprisingly high activities for oxygen reduction are found in the embodiments of the catalyst system both without platinum and with platinum. Using extremely loaded electrochemical investigations with CV measurements up to anodic potentials of 2000 mV NHE in sulfuric acid solution at pH=3 and T=85° C., it was also possible to demonstrate the high oxidation stability in 30-fold repeated cycles. It could even be shown that even up to 3000 mV NHE, especially in the phases rich in thoreaulite or β phase, the samples show very good resistance to passivation and dissolution.

Similar results were achieved with the same type of niobium-containing tin oxide composites. Niobium oxide has a slightly higher solubility in tin oxide than tantalum oxide. The limit solubility for niobium oxide is 2.5 at. %. With niobium oxide, stable stoichiometric phases SnNb₂0₇ (“froodite”) similar to the thoreaulite phase are formed. The activities measured are lower than with the tantalum-based catalyst systems, which can be explained by, among other things, the different pzzp values. However, it should be noted at this point that the activities depend very heavily on the manufacturing conditions.

The use of the catalyst system for future fuel cells brings with it considerable advantages, both economically and in terms of long-term stability and increased catalytic activity.

Furthermore, catalyst systems based on titanium niobium oxide were investigated. To increase the electrical conductivity, these oxides were doped with iridium. Doping of 0.1 mol % in the catalyst system was sufficient to set electrical conductivities σ>5*10² S/cm².

The catalyst system based on Ti—Ta—O has also proven itself to be useful with the setting of the two-phase region on the tantalum oxide-rich β phase, which in the two-phase region is in equilibrium with the stoichiometric phase Ti₃Ta₂O₁₁. Tantalum oxide has only a low solubility for titanium oxide in the β phase. In this phase, a pzzp value of pH=1 to 2 can be assumed, while the stoichiometric phase has a pzzp value above pH=4. In the context of the embodiments disclosed herein, a reverse setting was tested here, in which the active β phase functions as a carrier metal oxide and the stoichiometric phase is precipitated in nanodisperse form. In a further step, the surface of the coating 6—as described above—is covered with platinum metal islands.

The temperature treatment of the catalyst system has a great influence in several respects on the desired results with regard to the activity and electrical conductivity of the catalyst system. On the one hand, the density of the carrier metal oxide, for example the stoichiometric tin oxide, is set by means of the temperature treatment, taking into account the decomposition pressure of the compound at sintering temperatures above 950° C. On the other hand, the temperature treatment determines the precipitation conditions of the dispersoids, i.e., the catalyst material. For example, if the oxide is treated appropriately, pure Ta₂O₅ is precipitated at the grain boundaries of the tin oxide. It follows from this that the temperature treatment, as described above, must take place in such a way that the phases that are stable for fuel cell operation are established. For example, the SnO₂—Ta₂O₅ carrier material is produced in such a way that the starting materials are intimately mixed in the desired ratio in a ball mill and tempered at a temperature in the range of 700-800° C. under oxygen for a period of t1=30 min. It is then cooled to a temperature of 250° C. and this temperature is maintained for a period of time t2=1 h. Finally, the catalyst system is cooled to room temperature.

### LIST OF REFERENCE SYMBOLS

1, 1′ Electrode (cathode side)
2, 2′ Bipolar plate
2a, 2a′ Carrier plate
3a Inflow area
3b Outlet area
4, 4′ Opening
5 Gas distribution structure
6, 6′ Gas diffusion coating
7 Polymer electrolyte membrane
8 Coating (anode side)
9 Catalyst system
10 Fuel cell
100 Fuel cell system

1. A catalyst system comprising
an electrically conductive carrier metal oxide having an electrical conductivity σ1 of at least 10 S/cm, wherein the carrier metal oxide has at least two first metallic elements selected from the group of non-precious metals and has a structure comprising oxide grains with a grain size of at least 30 nm,
an electrically conductive, metal-oxide catalyst material having an electrical conductivity σ2 of at least 10 S/cm, wherein the catalyst material has at least one second metallic element from the group of non-precious metals, wherein the first metallic elements in the carrier metal oxide and the at least one second metallic element in the catalyst material are each present in a solid stoichiometric compound or solid homogeneous solution, wherein the carrier metal oxide and the catalyst material differ from one another in their composition and each are stabilized with fluorine, and
wherein a near-surface pH value, designated point of zero zeta potential (pzzp) of the carrier metal oxide and of the catalyst material differ from one another, wherein the pzzp value of either the carrier metal oxide or the catalyst material is at most pH=5, and the catalyst material and the carrier metal oxide form an at least two-phase disperse oxide composite.

2. The catalyst system according to claim 1, wherein the first metallic elements are formed by at least two metals from the group consisting of tin, tantalum, niobium, titanium, hafnium and zirconium.

3. The catalyst system according to claim 2, wherein the first metallic elements are formed by tin and furthermore by at least one metal from the group consisting of tantalum, niobium, titanium, hafnium and zirconium.

4. The catalyst system according to claim 1, wherein the at least one second metallic element is formed by at least one metal from the group comprising tantalum, niobium, titanium, hafnium, zirconium, iron and tungsten.

5. The catalyst system according claim 1, wherein the catalyst material has a structure comprising oxide grains with a grain size in the range from 1 nm to 50 nm.

6. The catalyst system according to claim 1, wherein the carrier metal oxide has a first crystal lattice structure comprising first oxygen lattice sites and first metal lattice sites, wherein the carrier metal oxide on the first metal lattice sites is doped with at least one element from the group comprising titanium, zirconium, hafnium, vanadium, niobium, tantalum, aluminum, iron, tungsten, molybdenum, iridium, rhodium, ruthenium and platinum.

7. The catalyst system according to claim 1, wherein the carrier metal oxide has a first crystal lattice structure comprising first oxygen lattice sites and first metal lattice sites, wherein the carrier metal oxide on the first oxygen lattice sites is doped with at least one element from the group comprising nitrogen, carbon and boron.

8. The catalyst system according to claim 1, wherein the catalyst material has a second crystal lattice structure comprising second oxygen lattice sites and second metal lattice sites, wherein the catalyst material on the second metal lattice sites is doped with at least one element from the group comprising titanium, zirconium, hafnium, vanadium, niobium, tantalum, iron, tungsten, molybdenum, iridium, rhodium, ruthenium and platinum.

9. The catalyst system according to claim 1, wherein platinum is applied to a surface of the catalyst system in an amount of at most 0.1 mg/cm².

10. An electrode comprising a catalyst system according to claim 1.

11. The electrode according to claim 10, which further comprises at least one ionomer and at least one binder.

12. The electrode according to claim 11, wherein the at least one binder comprises at least one fluorinated hydrocarbon or at least one polysaccharide.

13. The electrode according to claim 10, wherein the electrode has a coating thickness in the range of from 0.5 to 20 μm.

14. The electrode according to claim 10, wherein platinum is applied to a free surface of the electrode in an amount of at most 0.2 mg/cm².

15. An oxygen-hydrogen fuel cell or electrolyzer, comprising at least one electrode according to claim 10 and at least one polymer electrolyte membrane.

16. The fuel cell or electrolyzer according to claim 15, wherein the polymer electrolyte membrane and the ionomer in the electrode are formed from identical materials.
